(19) United States
(12) Patent Application Publication
(10) Pub. No.: US 2005/0169013 A1
(43) Pub. Date: Aug. 4, 2005

(54) Backlight module and liquid crystal display utilizing the same

(76) Inventors: Chuan-Pei Yu, Ilan (TW); Yun-Liang Huang, Taipei (TW); Hsin-Kuo Chang, Kaohsiung (TW); Hsin-Jou Chiu, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/832,068

(22) Filed: Apr. 26, 2004

(30) Foreign Application Priority Data
Feb. 2, 2004 (TW) 93102272

(51) Int. Cl. G02F 1/1335

(52) U.S. Cl. 362/629

(57) ABSTRACT

A backlight module and a liquid crystal display utilizing the same. The backlight module has a heat-dissipating port and a thermally actuated device disposed therein. When the temperature inside the backlight module exceeds a predetermined limit, the thermally actuated device starts to open the heat-dissipating port. When the temperature inside the backlight module drops below the predetermined limit, the thermally actuated device closes the heat-dissipating port. The extent of the port controlled by the thermally actuated device varies with the temperature inside the backlight module.

### BACKGROUND OF THE INVENTION

1. Field of the Invention

The invention relates to a backlight module for a liquid crystal display, and in particular, to a backlight module that can maintain optimum brightness under various conditions.

2. Description of the Related Art

In a liquid crystal display unit of a conventional liquid crystal display, a backlight module is used as a light source. According to the structure, backlight modules can be edge or direct types. Since the invention mainly aims at improving direct backlight modules, description of edge types is omitted.

As shown in FIG. 1, a direct backlight module 10 comprises a reflector 11, a diffuser plate 12, a plurality of fluorescent tubes 13, a support 14 for the fluorescent tubes 13, and two prism plates 15. The reflector 11 is located at the bottom of the backlight module 10 to reflect light from the fluorescent tubes 13 out of the backlight module 10. The reflector 11 comprises a base portion 111 and two upright portions 112, forming a box. The upright portions 112 are located on opposite sides of the base portion 111, and extend normally therefrom. The diffuser plate 12 is disposed on the reflector 11 in a manner such that it covers the fluorescent tubes 13 to form the backlight. The fluorescent tubes 13, the light source, are disposed on the support 14. A gap is formed between the fluorescent tubes 13 and the base portion 111 of the reflector 11. The prism plates 15 are located at the exit surface of the diffuser plate 12 to enhance brightness.

With recent demands for increased brightness of backlight modules, the number and the power of the fluorescent tubes have increased correspondingly, with temperature inside the backlight module increasing. As a result, even with increased number and power of fluorescent tubes, brightness of the backlight module cannot increase correspondingly. Specifically, temperature inside the backlight module is too high to decrease brightness.

To improve the above situation, a backlight module 20, 20a is disclosed in JP Pub. No. 2001-297623. As shown in FIGS. 2a and 2b, a plurality of ports 22, 23 are formed to control the temperature around the fluorescent tubes by means of convection. Thus, temperature inside the backlight module cannot be too high to decrease brightness.

Nevertheless, since the ports are always open, the fluorescent tubes cannot achieve optimum temperature. Specifically, before temperature of the fluorescent tubes achieves optimum temperature, heat inside the backlight module dissipates through the ports. Thus, brightness of the backlight module cannot be optimized. Additionally, dust and other contaminants may enter the backlight module via the ports.

### SUMMARY OF THE INVENTION

In view of this, the invention provides a backlight module with a heat-dissipating device to enhance its brightness.

Another purpose of the invention is to provide a liquid crystal display with a heat-dissipating device operable at optimum temperature.

Accordingly, the invention provides a backlight module comprising a reflector and a thermally actuated device. The reflector comprises a heat-dissipating port, in which the thermally actuated device is disposed. When the temperature inside the backlight module exceeds a predetermined limit, the thermally actuated device starts to open the heat-dissipating port. When the temperature inside the backlight module drops below the predetermined limit, the thermally actuated device closes the heat-dissipating port. The extent of the port controlled by the thermally actuated device varies with the temperature inside the backlight module.

In a preferred embodiment, the thermally actuated device comprises a first material and a second material, with thermal expansion coefficient of the first material different from that of the second. Both materials are made of what are sensitive to temperature variations, such as titanium, aluminum, iron, copper, or rubber.

In another preferred embodiment, the reflector comprises a base portion and two upright portions, forming a box. The heat-dissipating port may be formed in either the base portion or the upright portions.

Furthermore, the backlight module comprises a diffuser plate and a prism plate. The diffuser plate is disposed between the upright portions in a manner such that the diffuser plate and the base portion are separated by a predetermined distance. The prism plate is disposed between the upright portions so that the diffuser plate is located between the prism plate and the base portion of the reflector.

In another preferred embodiment, the backlight module further comprises a support and a lamp. The support may be disposed on the reflector. The lamp is disposed on the support in a manner such as to not contact the reflector. The lamp may be a fluorescent tube.

In the invention, a liquid crystal display is also provided, comprising a frame, a backlight module, and a thermally actuated device. The frame comprises a heat-dissipating port. The backlight module is disposed in the frame. The thermally actuated device is disposed with the heat-dissipating port. When the temperature inside the backlight module exceeds a predetermined limit, the thermally actuated device starts to open the heat-dissipating port. When the temperature inside the backlight module drops below the predetermined limit, the thermally actuated device closes the heat-dissipating port. The extent of the port controlled by the thermally actuated device varies with the temperature inside the backlight module. When the temperature inside the backlight module exceeds that of the exterior, air flows out from the backlight module to the exterior. Thus, contaminants entering the backlight module are reduced, and the temperature inside the backlight module is effectively controlled.

In the invention, another liquid crystal display is provided, comprising a frame, a backlight module, and a thermally actuated device. The backlight module is disposed in the frame, and comprises a heat-dissipating port. The thermally actuated device is disposed in the heat-dissipating port. When the temperature inside the backlight module exceeds a predetermined limit, the thermally actuated device starts to open the heat-dissipating port. When the temperature inside the backlight module drops below the predetermined limit, the thermally actuated device closes the heat-dissipating port. The extent of the port controlled by the thermally actuated device varies with the temperature inside the backlight module.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional direct backlight module;

FIGS. 2a and 2b are schematic views of a backlight module as disclosed in JP Pub. No. 2001-297623;

FIG. 3 is a schematic view of a backlight module with a heat-dissipating device as disclosed in the invention;

FIG. 4a is a partially enlarged view of a frame and a thermally actuated device in FIG. 3, wherein the thermally actuated device is open;

FIG. 4b is a partially enlarged view of the frame and the thermally actuated device in FIG. 3, wherein the thermally actuated device is closed; and

FIG. 5 is a schematic view of a liquid crystal display with a heat-dissipating device as disclosed in the invention.

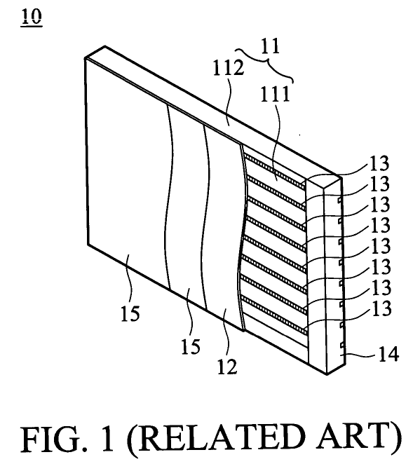

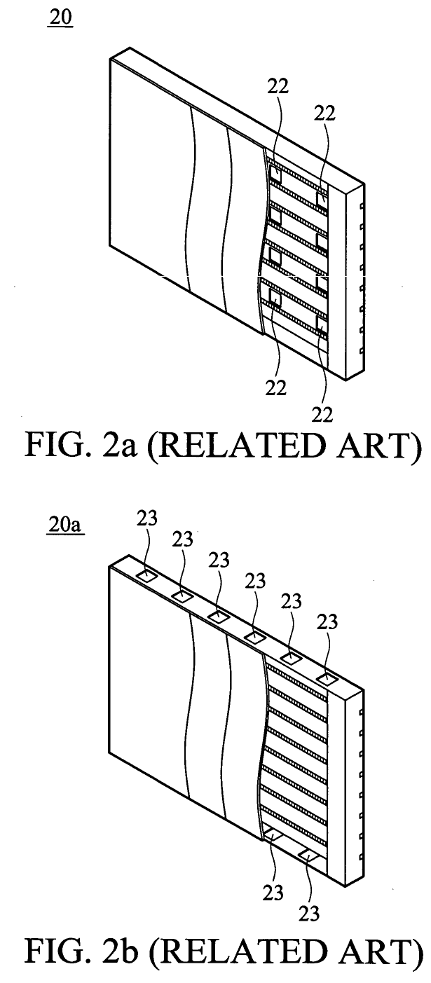

### DETAILED DESCRIPTION OF THE INVENTION

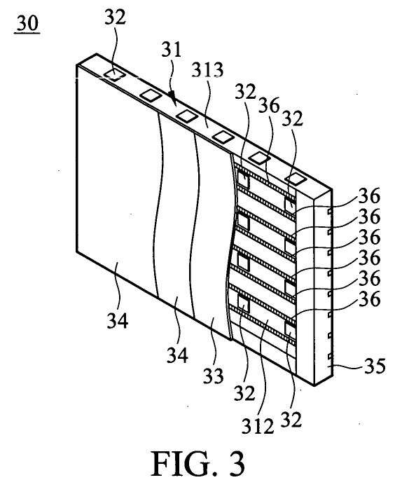

FIG. 3 shows a backlight module 30 with a heat-dissipating device as disclosed in the invention. The backlight module comprises a reflector 31, a plurality of thermally actuated devices 32, a diffuser plate 33, two prism plates 34, a support 35, and a plurality of lamps 36. The reflector 31 is located at the bottom of the backlight module 30, and comprises a base portion 312 and two upright portions 313, forming a box. A plurality of heat-dissipating ports 311 are formed in the base portion 312 and the upright portions 313. While the heat-dissipating ports 311 are formed in the base portion 312 and the upright portions 313 in FIG. 3, however, the invention is not limited thereto. For example, the heat-dissipating ports may be formed only in the base portion 312 or the upright portions 313.

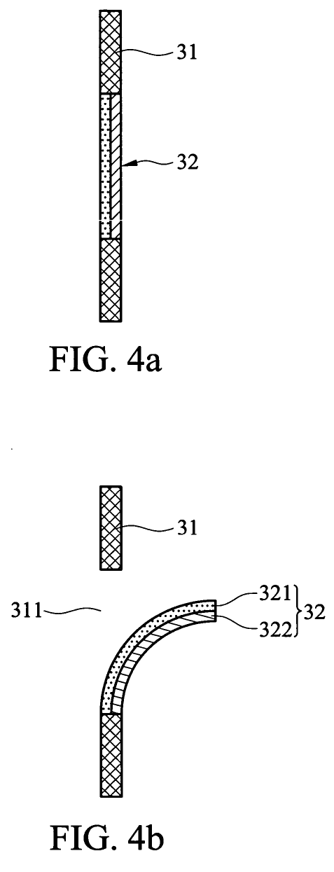

In the embodiment, each thermally actuated device 32 is disposed in the heat-dissipating port 311 of the reflector 31 respectively, and formed by two materials with different thermal expansion coefficients. Referring to FIGS. 4a and 4b, each thermally actuated device 32 comprises a first material 321 and a second material 322, the thermal expansion coefficient of the first material 321 being different from that of the second material 322. When the temperature inside the backlight module 30 increases due to operation of the lamps 36, exceeding a predetermined limit, the thermally actuated device 32 is heated and bends toward the second material 322 (of lower thermal expansion coefficient), opening the heat-dissipating port 311 as shown in FIG. 4b. When the temperature inside the backlight module 30 decreases due to dissipation through ports 311, falling below the predetermined limit, the thermally actuated device 32 returns to its original shape, closing the heat-dissipating port 311 as shown in FIG. 4a.

It is noted that the above predetermined limit is defined by an optimum operating temperature of the lamp 36. Thus, the lamp 36 operates at the optimum temperature (about 40-50° C.). As a result, brightness generated by the backlight module 30 is optimized.

Additionally, the opening extent of the heat-dissipating port 311, controlled by the thermally actuated device 32, varies with the temperature inside the backlight module 30.

Furthermore, both the first material 321 and the second material 322 may be titanium, aluminum, iron, copper, SUS 304 (stainless steel), SS41 (stainless steel), or rubber respectively.

Additionally, the diffuser plate 33 is disposed between the upright portions 313 of the reflector 31 in a manner such that the diffuser plate 33 and the base portion 312 of the reflector 31 are separated by a predetermined distance. The prism plates 34 are disposed between the upright portions 313 of the reflector 31 so that the diffuser plate 33 is located between the prism plates 34 and the base portion 312 of the reflector 31. The support 35 is disposed on the reflector 31 to support the lamps 36. Each lamp 36 is disposed on the support 35 without contacting the reflector 31. Each lamp 36 is a light source of the backlight module 30, and may be a fluorescent tube.

As stated above, the thermally actuated device disposed in the heat-dissipating port of the reflector opens the heat-dissipating port to dissipate heat when the temperature inside the backlight module exceeds a predetermined limit, and closes the heat-dissipating port when the temperature inside the backlight module drops below the predetermined limit. Thus, heat generated by the lamp is dissipated efficiently, allowing the lamp to quickly achieve and maintain optimum operating temperature. The extra heat can be then dissipated.

Furthermore, since the temperature inside the backlight module exceeds that of the exterior, air flows out from the backlight module to the exterior. Thus, contaminants entering the backlight module are reduced, and the temperature inside the backlight module is effectively controlled.

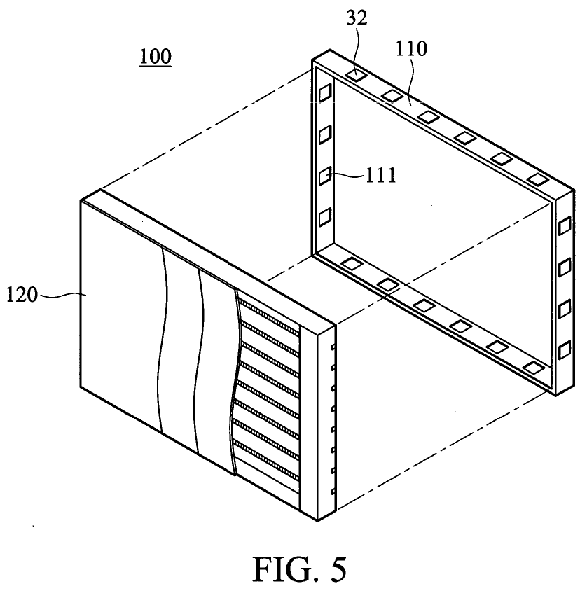

While the thermally actuated device is disposed in the reflector in the embodiment, however, the invention is not limited thereto. For example, the thermally actuated device can be disposed in any position on the backlight module except the panel. Additionally, the thermally actuated device is not limited to disposition in the backlight module. For example, FIG. 5 shows a liquid crystal display 100 with a heat-dissipating device, comprising a frame 110 and a backlight module 120, wherein the frame 110 is provided with a plurality of heat-dissipating ports 111 with the thermally actuated device 32 therein. Thus, the backlight module can be operated at an optimum operating temperature.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A backlight module comprising:
a reflector comprising a heat-dissipating port; and
a thermally actuated device disposed with the heat-dissipating port, wherein the thermally actuated device starts to open the heat-dissipating port when the temperature inside the backlight module exceeds a predetermined limit.

2. The backlight module as claimed in claim 1, wherein the extent of the port controlled by the actuated device varies with the temperature.

3. The backlight module as claimed in claim 1, wherein the thermally actuated device comprises a first material and a second material, with thermal expansion coefficient of the first material different from that of the second material.

4. The backlight module as claimed in claim 3, wherein the first material is titanium, aluminum, iron, copper, or rubber.

5. The backlight module as claimed in claim 3, wherein the second material is titanium, aluminum, iron, copper, or rubber.

6. The backlight module as claimed in claim 1, wherein the reflector comprises a base portion and two upright portions, forming a box.

7. The backlight module as claimed in claim 6, wherein the heat-dissipating port is formed in the base portion.

8. The backlight module as claimed in claim 6, wherein the heat-dissipating port is formed in the upright portions.

9. The backlight module as claimed in claim 6, further comprising a diffuser plate disposed between the upright portions in a manner such that the diffuser plate and the base portion are separated by a predetermined distance.

10. The backlight module as claimed in claim 9, further comprising a prism plate disposed between the upright portions so that the diffuser plate is located between the prism plate and the base portion of the reflector.

11. A liquid crystal display comprising:
a frame comprising a heat-dissipating port;
a backlight module disposed in the frame; and
a thermally actuated device disposed with the heat-dissipating port, wherein the thermally actuated device starts to open the heat-dissipating port when the temperature inside the backlight module exceeds a predetermined limit.

12. The backlight module as claimed in claim 11, wherein the extent of the port controlled by the actuated device varies with the temperature.

13. The liquid crystal display as claimed in claim 11, wherein the thermally actuated device comprises a first material and a second material, with thermal expansion coefficient of the first material different from that of the second material.

14. The liquid crystal display as claimed in claim 13, wherein the first material is titanium, aluminum, iron, copper, or rubber.

15. The liquid crystal display as claimed in claim 13, wherein the second material is titanium, aluminum, iron, copper, or rubber.

16. A liquid crystal display comprising:
a frame;
a backlight module, comprising a heat-dissipating part, disposed in the frame; and
a thermally actuated device disposed with the heat-dissipating part, wherein the thermally actuated device starts to open the heat-dissipating part when the temperature inside the backlight module exceeds a predetermined limit.

17. The backlight module as claimed in claim 16, wherein the extent of the part controlled by the actuated device varies with the temperature.

18. The liquid crystal display as claimed in claim 16, wherein the thermally actuated device comprises a first material and a second material, with thermal expansion coefficient of the first material different from that of the second material.

19. The liquid crystal display as claimed in claim 18, wherein the first material is titanium, aluminum, iron, copper, or rubber.

20. The liquid crystal display as claimed in claim 18, wherein the second material is titanium, aluminum, iron, copper, or rubber.
